(19) United States
(12) Patent Application Publication
(10) Pub. No.: US 2025/0386128 A1
(43) Pub. Date: Dec. 18, 2025

(54) WIRELESS HEADSET

(71) Applicant: Cheng Uei Precision Industry Co., Ltd., New Taipei City (TW)

(72) Inventors: Chung Che Li, New Taipei City (TW); Yun Jhong Chen, New Taipei City (TW); Yung Mao Wu, New Taipei City (TW)

(21) Appl. No.: 18/991,885

(22) Filed: Dec. 23, 2024

(30) Foreign Application Priority Data
Jun. 13, 2024 (CN) 202410759125.6

(51) Int. Cl. H04R 1/10; H02J 7/00; H02J 7/34

(52) U.S. Cl. CPC H04R 1/1025; H02J 7/00034; H02J 7/0063; H02J 7/342; H04R 1/1041; H02J 2310/22

(57) ABSTRACT

A wireless headset includes a charging contact set on a housing surface of the wireless headset, a microcontroller arranged inside the wireless headset, and a resetting circuit. The microcontroller is set to reset the wireless headset when the microcontroller receives a resetting signal. The charging contact is electrically connected to the microcontroller to charge a first battery module arranged inside the wireless headset. The resetting circuit is arranged inside the wireless headset. The resetting circuit is electrically connected between the charging contact and the microcontroller. When the charging contact is connected to an external power source. The resetting circuit sends a resetting signal to the microcontroller, and the resetting circuit resets the wireless headset. The microcontroller is equipped with a resetting port to receive the resetting signal.

### CROSS REFERENCE TO RELATED APPLICATIONS

The present application is based on, and claims priority from, China Patent Application No. 202410759125.6, filed Jun. 13, 2024, the disclosure of which is hereby incorporated by reference herein in its entirety.

### BACKGROUND OF THE INVENTION

### Field of the Invention

The present invention generally relates to a wireless headset, and more particularly to a wireless headset which is able to be reset without increasing an additional pressing button.

### Description of Related Art

Occasionally, a wireless headset may occur an abnormal operation condition, for example, a wireless headset may be connected with other devices unstably, or shut down suddenly during an operation of the wireless headset. At the moment, the wireless headset is reset to a factory setting to solve most of running errors so as to ensure that the wireless headset is without being affected by the previous running errors in a new round of operation.

However, electronic devices, such as the wireless headsets, tend to be developed towards a direction of having a minimized appearance and simplifying a design of the wireless headset due to a guiding direction of a current market, correspondingly, the wireless headsets are mostly without having spare spaces for arranging special resetting buttons on the wireless headsets.

Therefore, it is necessary to provide a wireless headset which is able to be reset without increasing an additional pressing button. The wireless headset is able to be reset before a new running process, and the wireless headset is needless of disposing the additional pressing button on a surface of the wireless headset.

### BRIEF SUMMARY OF THE INVENTION

An object of the present invention is to provide a wireless headset, comprising: a charging contact being disposed on a housing surface of the wireless headset; a microcontroller being arranged inside the wireless headset, the microcontroller being capable of resetting the wireless headset when the microcontroller receives a resetting signal, the charging contact being electrically connected to the microcontroller to transmit a charging voltage; and a resetting circuit being arranged inside the wireless headset, the resetting circuit being electrically connected between the charging contact and the microcontroller, when the charging contact transmits the charging voltage to the resetting circuit, the resetting circuit pulling down the charging voltage and then sending a resetting signal to the microcontroller, wherein the microcontroller is equipped with a resetting port to receive the resetting signal, and the resetting signal is a low-level signal.

Another object of the present invention is to provide a wireless headset, comprising: a charging contact being disopsed on a housing of the wireless headset; a microcontroller being arranged inside the wireless headset, the microcontroller being equipped with a resetting port, the microcontroller being capable of resetting the wireless headset when the microcontroller receives a resetting signal via the resetting port, the charging contact being electrically connected to the microcontroller to transmit a charging voltage; and a resetting circuit being arranged inside the wireless headset, the resetting circuit being electrically connected between the charging contact and the microcontroller, when the charging contact transmits the charging voltage to the resetting circuit, the resetting circuit pulling down the charging voltage and then sending the resetting signal to the microcontroller, wherein the resetting circuit has a voltage dividing circuit, a first inverter, an integrator, a schmitt trigger, a differentiator and a second inverter, the voltage dividing circuit is electrically connected to the charging contact, the voltage dividing circuit is capable of reducing the charging voltage into a dividing voltage, the first inverter is electrically connected to an outputting end of the voltage dividing circuit to invert the dividing voltage and output an inverting signal, the integrator is electrically connected between the first inverter and the schmitt trigger to integrate the inverting signal and to output an integration signal, the schmitt trigger has a first inputting end and a second inputting end, the first inputting end is electrically connected to the integrator to receive the integration signal, and the second inputting end is electrically connected to an outputting end of the second inverter to receive the resetting signal, the schmitt trigger compares the integration signal with the resetting signal, and the schmitt trigger outputs a rectifying signal, the differentiator is electrically connected between the schmitt trigger and the second inverter to differentiate the rectifying signal and output a differential signal, the second inverter is electrically connected to the resetting port to reinforce the differential signal and output the resetting signal.

Another object of the present invention is to provide a wireless headset adapted for being cooperated with a charging case, comprising: a charging contact being disposed to a housing of the wireless headset; a microcontroller being arranged inside the wireless headset, the microcontroller being equipped with a resetting port, the microcontroller being capable of resetting the wireless headset when the microcontroller receives a resetting signal via the resetting port, the charging contact being electrically connected to the microcontroller to transmit a charging voltage; and a resetting circuit being arranged inside the wireless headset, the resetting circuit being electrically connected between the charging contact and the resetting port of the microcontroller, when the charging contact is connected to a connector of the charging case, the resetting circuit sending the resetting signal to the resetting port of the microcontroller, wherein the resetting circuit includes a voltage dividing circuit electrically connected to the charging contact, a first inverter, an integrator, a schmitt trigger, a differentiator and a second inverter, the voltage dividing circuit is capable of reducing the charging voltage into a dividing voltage, the first inverter is electrically connected to an outputting end of the voltage dividing circuit to invert a signal of the dividing voltage and output an inverting signal, the integrator is electrically connected between the first inverter and the schmitt trigger to integrate the inverting signal and to output an integration signal, the schmitt trigger has a first inputting end and a second inputting end, the first inputting end is electrically connected to the integrator to receive the integration signal, and the second inputting end is electrically connected to an outputting end of the second inverter to receive the resetting signal, the schmitt trigger compares the integration signal with the resetting signal, and the schmitt trigger outputs a rectifying signal, the differentiator is electrically connected between the schmitt trigger and the second inverter to differentiate the rectifying signal and output a differential signal, the second inverter is electrically connected to the resetting port to reinforce the differential signal and output the resetting signal, and wherein when the wireless headset is placed inside the charging case and the charging contact is connected to the connector, the wireless headset is reset.

As described above, the wireless headset is provided with the resetting circuit between the charging contact and the microcontroller. When the charging case charges the wireless headset, the charging contact contacts a spring connector, the resetting circuit reduces the charging voltage received by the charging contact and outputs the low-level resetting signal, so that the microcontroller resets the wireless headset to reboot the wireless headset, and the wireless headset is ensured to be reset before an operation of the wireless headset to improve an operation stability of the wireless headset. As a result, the wireless headset is able to be reset without increasing an additional pressing button.

### BRIEF DESCRIPTION OF THE DRAWINGS

The present invention will be apparent to those skilled in the art by reading the following

description, with reference to the attached drawings, in which:

FIG. 1 shows a structure diagram of a charging case and a wireless headset in accordance with a preferred embodiment of the present invention; and

FIG. 2 shows a circuit diagram of the wireless headset in accordance with the present invention.

### DETAILED DESCRIPTION OF THE INVENTION

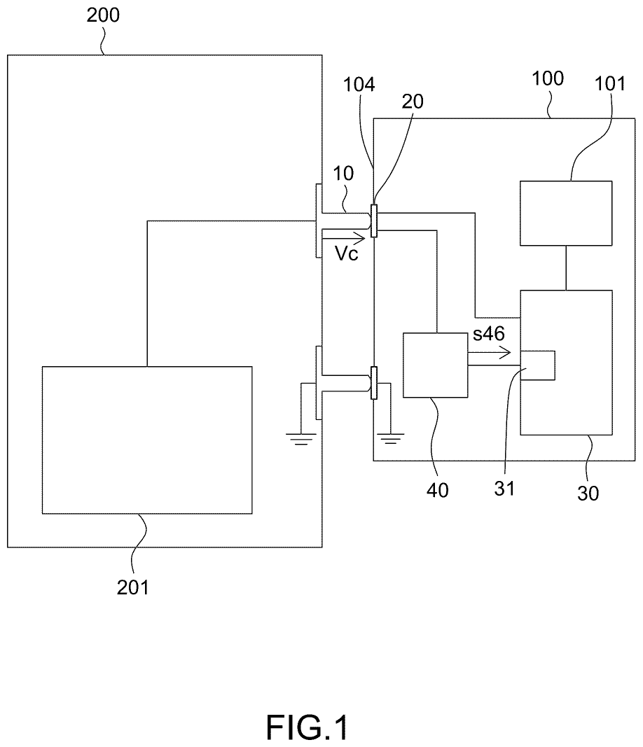

Referring to FIG. 1, a wireless headset 100 in accordance with a preferred embodiment of the present invention is shown. The wireless headset 100 is adapted for being cooperated with a charging case 200. When the wireless headset 100 is placed inside the charging case 200, the wireless headset 100 is reset. The wireless headset 100 includes a charging contact 20 disposed on a housing surface 104 of the wireless headset 100, a microcontroller 30 arranged inside the wireless headset 100, and a resetting circuit 40 arranged inside the wireless headset 100. The resetting circuit 40 is electrically connected between the charging contact 20 and the microcontroller 30.

The microcontroller 30 is capable of resetting the wireless headset 100 when the microcontroller 30 receives a resetting signal s46. The charging contact 20 is electrically connected to the microcontroller 30 to transmit energy to a first battery module 101 arranged inside the wireless headset 100. The charging case 200 includes a second battery module 201. Therefore, when the charging contact 20 is connected to an external power source which is the second battery module 201 of the charging case 200, the resetting circuit 40 sends the resetting signal s46 to the microcontroller 30, and the resetting circuit 40 resets the wireless headset 100. The second battery module 201 provides the energy to the first battery module 101 via the charging contact 20.

With reference to FIG. 1, the second battery module 201 is arranged inside the charging case 200. The charging case 200 further includes a spring connector 10. The spring connector 10 is disposed to the charging case 200, and the spring connector 10 protrudes to be exposed to the charging case 200. The spring connector 10 is adapted to the charging contact 20. The spring connector 10 is cooperated with the charging contact 20. The second battery module 201 is electrically connected to the spring connector 10 of the charging case 200 to provide a charging voltage Vc. The charging contact 20 is connected to the second battery module 201 of the charging case 200. The microcontroller 30 is equipped with a resetting port 31 to receive the resetting signal s46, and the resetting signal s46 is a low-level signal. The microcontroller 30 resets the wireless headset 100 when the resetting port 31 is at a low level. When the charging contact 20 contacts with the spring connector 10, the second battery module 201 charges the first battery module 101, and simultaneously, the resetting circuit 40 pulls down the charging voltage Vc, and the resetting circuit 40 outputs the low-level resetting signal s46 to the resetting port 31, so the microcontroller 30 resets the wireless headset 100.

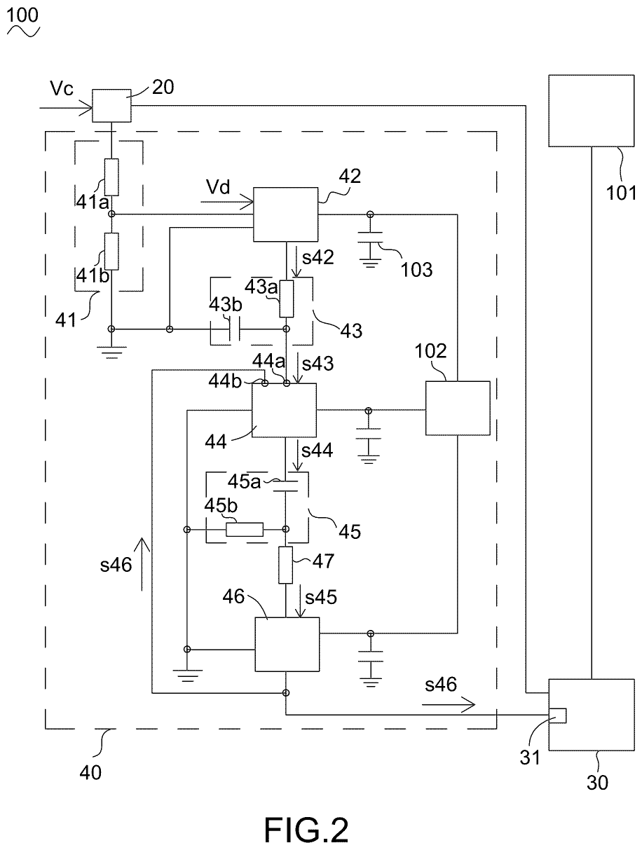

Referring to FIG. 1 and FIG. 2, the resetting circuit 40 is capable of pulling down the charging voltage Vc, and the resetting circuit 40 generates the low-level resetting signal s46. The resetting circuit 40 includes a voltage dividing circuit 41, a first inverter 42, an integrator 43, a schmitt trigger 44, a differentiator 45 and a second inverter 46. The first inverter 42, the schmitt trigger 44 and the second inverter 46 are all electrically connected to a power supply circuit 102. The first inverter 42, the schmitt trigger 44, the second inverter 46 and the power supply circuit 102 are electrically connected to a capacitance 103 to filter out current noises.

Referring to FIG. 2, the voltage dividing circuit 41 is electrically connected to the charging contact 20. The voltage dividing circuit 41 is capable of reducing a value of the charging voltage Vc into a dividing voltage Vd. The voltage dividing circuit 41 includes a first resistance 41a and a second resistance 41b. The first resistance 41a and the second resistance 41b are connected in series. One end of the first resistance 41a is electrically connected to the charging contact 20, and one end of the second resistance 41b is grounded. The other end of the first resistance 41a is electrically connected to the other end of the second resistance 41b and the first inverter 42. The first inverter 42 is electrically connected to an outputting end of the voltage dividing circuit 41 to invert the dividing voltage Vd which is outputted by the voltage dividing circuit 41 and output an inverting signal s42. The first inverter 42 is electrically connected to the first resistance 41a and the second resistance 41b to invert the dividing voltage Vd which is outputted by the voltage dividing circuit 41 and output the inverting signal s42.

Referring to FIG. 2 again, the integrator 43 is electrically connected between the first inverter 42 and the schmitt trigger 44 to integrate the inverting signal s42 and to output an integration signal s43, so that a waveform of the inverting signal s42 is smooth for stabilizing circuit signals which include the inverting signal s42. The integrator 43 is able to be a circuit which is composed of multiple resistors and capacitors, and the circuit which is composed of the multiple resistors and the capacitors has a function similar to the integrator 43. The integrator 43 includes a first resistor 43a and a first capacitor 43b. One end of the first resistor 43a is electrically connected to an outputting end of the first inverter 42, and the other end of the first resistor 43a is electrically connected to a first inputting end 44a of the schmitt trigger 44 and one end of the first capacitor 43b. The other end of the first capacitor 43b is grounded.

Continue referring to FIG. 2, the schmitt trigger 44 has the first inputting end 44a and a second inputting end 44b. The first inputting end 44a is electrically connected to the integrator 43 to receive the integration signal s43, and the second inputting end 44b is electrically connected to an outputting end of the second inverter 46 to receive the resetting signal s46. The schmitt trigger 44 compares the integration signal s43 with the resetting signal s46, and the schmitt trigger 44 outputs a rectifying signal s44. In this present invention, an operation principle of the schmitt trigger 44 is similar to a NAND gate. When at least one of the integration signal s43 and the resetting signal s46 is at the low level, the schmitt trigger 44 outputs the high-level rectifying signal s44.

Referring to FIG. 2, the differentiator 45 is electrically connected between the schmitt trigger 44 and the second inverter 46 to differentiate the rectifying signal s44 and output a differential signal s45 so as to strengthen a variation of the rectifying signal s44 and filter out noises, and the circuit signals are stabilized. The differentiator 45 is able to be an electrocircuit which is composed of the multiple resistors and capacitors and has a function similar to the differentiator 45. In this present invention, the differentiator 44 includes a second capacitor 45a and a second resistor 45b. One end of the second capacitor 45a is electrically connected to an outputting end of the schmitt trigger 44, and the other end of the second capacitor 45a is electrically connected to one end of the second resistor 45b. The other end of the second resistor 45b is grounded.

The resetting circuit 40 further includes a third resistor 47 connected between the second capacitor 45a and an inputting end of the second inverter 46. The second capacitor 45a is further electrically connected to the third resistor 47, and then the second capacitor 45a is connected to the inputting end of the second inverter 46 for reducing an intensity of a current flowing from the outputting end of the schmitt trigger 44 to the second inverter 46, thereby ensuring a stable circuit operation. The second inverter 46 is configured to reinforce the differential signal s45 outputted by the differentiator 45, and a current intensity is enhanced, thereby ensuring a stability of a signal in a subsequent circuit. In addition, the second inverter 46 is electrically connected to the resetting port 31 to reinforce the differential signal s45 and output the resetting signal s46.

Referring to FIG. 1 and FIG. 2, a process of resetting the wireless headset 100 in accordance with the present invention is described as follows. The first battery module 101 and the second battery module 201 are both rechargeable modules. The charging voltage Vc which is provided by the second battery module 201 is 5V. When the second battery module 201 is capable of supplying power, and the user places the wireless headset 100 into the charging case 200, the spring connector 10 contacts the charging contact 20, and a current path between the wireless headset 100 and the charging case 200 is formed, so that the charging contact 20 receives the charging voltage Vc through the spring connector 10, the resetting circuit 40 reduces the charging voltage Vc and the resetting circuit 40 rectifies the charging voltage Vc to transmit the low-level resetting signal s46 to the resetting port 31 of the microcontroller 30. When the microcontroller 30 detects that the resetting port 31 is at the low level, the wireless headset 100 is reset.

As described above, the wireless headset 100 is provided with the resetting circuit 40 between the charging contact 20 and the microcontroller 30. When the charging case 200 charges the wireless headset 100, the charging contact 20 contacts the spring connector 10, the resetting circuit 40 reduces the charging voltage Vc received by the charging contact 20 and outputs the low-level resetting signal s46, so that the microcontroller 30 resets the wireless headset 100 to reboot the wireless headset 100, and the wireless headset 100 is ensured to be reset before an operation of the wireless headset 100 to improve an operation stability of the wireless headset 100. As a result, the wireless headset 100 is able to be reset without increasing an additional pressing button.

Though the present invention is disclosed as the above-mentioned preferred embodiment, the preferred embodiment disclosed in this invention is without being intended to limit a scope of this invention. In related technical fields, anyone with ordinary knowledges should be able to make a few changes and embellishments within a spirit and a protection scope of this invention, so the protection scope of this invention should regard defined claims of an attached application patent as a standard.

What is claimed is:

1. A wireless headset, comprising:
a charging contact being disposed on a housing surface of the wireless headset;
a microcontroller being arranged inside the wireless headset, the microcontroller being capable of resetting the wireless headset when the microcontroller receives a resetting signal, the charging contact being electrically connected to the microcontroller to transmit a charging voltage; and
a resetting circuit being arranged inside the wireless headset, the resetting circuit being electrically connected between the charging contact and the microcontroller, when the charging contact transmits the charging voltage to the resetting circuit, the resetting circuit pulling down the charging voltage and then sending a resetting signal to the microcontroller, wherein the microcontroller is equipped with a resetting port to receive the resetting signal, and the resetting signal is a low-level signal.

2. The wireless headset as claimed in claim 1, wherein the resetting circuit has a voltage dividing circuit, a first inverter and an integrator, the voltage dividing circuit is electrically connected to the charging contact, the voltage dividing circuit is capable of reducing a value of a charging voltage into a dividing voltage, the first inverter is electrically connected to an outputting end of the voltage dividing circuit to invert the dividing voltage and output an inverting signal, the integrator is electrically connected to the first inverter to integrate the inverting signal and to output an integration signal.

3. The wireless headset as claimed in claim 2, wherein the resetting circuit has a schmitt trigger, a differentiator and a second inverter, the integrator is electrically connected between the first inverter and the schmitt trigger, the schmitt trigger has a first inputting end and a second inputting end, the first inputting end is electrically connected to the integrator to receive the integration signal, and the second inputting end is electrically connected to an outputting end of the second inverter to receive the resetting signal, the schmitt trigger compares the integration signal with the resetting signal, and the schmitt trigger outputs a rectifying signal, the differentiator is electrically connected between the schmitt trigger and the second inverter to differentiate the rectifying signal and output a differential signal, the second inverter is electrically connected to the resetting port to reinforce the differential signal and output the resetting signal.

4. The wireless headset as claimed in claim 3, wherein the integrator has a first resistor and a first capacitor, one end of the first resistor is electrically connected to an outputting end of the first inverter, and the other end of the first resistor is electrically connected to the first inputting end of the schmitt trigger and one end of the first capacitor, the other end of the first capacitor is grounded.

5. The wireless headset as claimed in claim 4, wherein the differentiator has a second capacitor and a second resistor, one end of the second capacitor is electrically connected to an outputting end of the schmitt trigger, and the other end of the second capacitor is electrically connected to one end of the second resistor, the other end of the second resistor is grounded, the resetting circuit has a third resistor connected between the second capacitor and an inputting end of the second inverter.

6. The wireless headset as claimed in claim 3, wherein the first inverter, the schmitt trigger and the second inverter are all electrically connected to a power supply circuit.

7. The wireless headset as claimed in claim 2, wherein the voltage dividing circuit has a first resistance and a second resistance, the first resistance and the second resistance are connected in series, one end of the first resistance is electrically connected to the charging contact, one end of the second resistance is grounded, the other end of the first resistance is electrically connected to the other end of the second resistance and the first inverter.

8. The wireless headset as claimed in claim 1, wherein when the wireless headset is placed inside a charging case, the wireless headset is reset, the charging voltage is provided from a second battery module, and the second battery module is arranged inside the charging case, the charging case has a spring connector, the spring connector is disposed to the charging case, the spring connector is cooperated with the charging contact, the second battery module is electrically connected to the spring connector of the charging case to provide the charging voltage.

9. A wireless headset, comprising:
a charging contact being disopsed on a housing of the wireless headset;
a microcontroller being arranged inside the wireless headset, the microcontroller being equipped with a resetting port, the microcontroller being capable of resetting the wireless headset when the microcontroller receives a resetting signal via the resetting port, the charging contact being electrically connected to the microcontroller to transmit a charging voltage; and
a resetting circuit being arranged inside the wireless headset, the resetting circuit being electrically connected between the charging contact and the microcontroller, when the charging contact transmits the charging voltage to the resetting circuit, the resetting circuit pulling down the charging voltage and then sending the resetting signal to the microcontroller,
wherein the resetting circuit has a voltage dividing circuit, a first inverter, an integrator, a schmitt trigger, a differentiator and a second inverter, the voltage dividing circuit is electrically connected to the charging contact, the voltage dividing circuit is capable of reducing the charging voltage into a dividing voltage, the first inverter is electrically connected to an outputting end of the voltage dividing circuit to invert the dividing voltage and output an inverting signal, the integrator is electrically connected between the first inverter and the schmitt trigger to integrate the inverting signal and to output an integration signal, the schmitt trigger has a first inputting end and a second inputting end, the first inputting end is electrically connected to the integrator to receive the integration signal, and the second inputting end is electrically connected to an outputting end of the second inverter to receive the resetting signal, the schmitt trigger compares the integration signal with the resetting signal, and the schmitt trigger outputs a rectifying signal, the differentiator is electrically connected between the schmitt trigger and the second inverter to differentiate the rectifying signal and output a differential signal, the second inverter is electrically connected to the resetting port to reinforce the differential signal and output the resetting signal.

10. A wireless headset adapted for being cooperated with a charging case, comprising:
a charging contact being disposed to a housing of the wireless headset;
a microcontroller being arranged inside the wireless headset, the microcontroller being equipped with a resetting port, the microcontroller being capable of resetting the wireless headset when the microcontroller receives a resetting signal via the resetting port, the charging contact being electrically connected to the microcontroller to transmit a charging voltage; and
a resetting circuit being arranged inside the wireless headset, the resetting circuit being electrically connected between the charging contact and the resetting port of the microcontroller, when the charging contact is connected to a connector of the charging case, the resetting circuit sending the resetting signal to the resetting port of the microcontroller, wherein the resetting circuit includes a voltage dividing circuit electrically connected to the charging contact, a first inverter, an integrator, a schmitt trigger, a differentiator and a second inverter, the voltage dividing circuit is capable of reducing the charging voltage into a dividing voltage, the first inverter is electrically connected to an outputting end of the voltage dividing circuit to invert a signal of the dividing voltage and output an inverting signal, the integrator is electrically connected between the first inverter and the schmitt trigger to integrate the inverting signal and to output an integration signal, the schmitt trigger has a first inputting end and a second inputting end, the first inputting end is electrically connected to the integrator to receive the integration signal, and the second inputting end is electrically connected to an outputting end of the second inverter to receive the resetting signal, the schmitt trigger compares the integration signal with the resetting signal, and the schmitt trigger outputs a rectifying signal, the differentiator is electrically connected between the schmitt trigger and the second inverter to differentiate the rectifying signal and output a differential signal, the second inverter is electrically connected to the resetting port to reinforce the differential signal and output the resetting signal, and wherein when the wireless headset is placed inside the charging case and the charging contact is connected to the connector, the wireless headset is reset.
